(19) United States
(12) Patent Application Publication
(10) Pub. No.: US 2008/0198437 A1
(43) Pub. Date: Aug. 21, 2008

(54) CONVERTING OPTICAL INFORMATION ENCODING

(75) Inventors: Jeffrey H. Shapiro, Sharon, MA (US); Franco N. C. Wong, Lexington, MA (US)

Correspondence Address: FISH & RICHARDSON PC, P.O. BOX 1022, MINNEAPOLIS, MN, 55440-1022, US

(73) Assignee: MASSACHUSETTS INSTITUTE OF TECHNOLOGY, Cambridge, MA (US)

(21) Appl. No.: 11/760,212

(22) Filed: Jun. 8, 2007

Related U.S. Application Data
(60) Provisional application No. 60/822,800, filed on Aug. 18, 2006.

(51) Int. Cl. G02F 1/01

(52) U.S. Cl. 359/238

(57) ABSTRACT

An apparatus that converts information encoding on an electromagnetic wave includes a delay module and a time-dependent module. The delay module is configured to apply a first time delay to a first component of an electromagnetic wave and to apply a second time delay different from the first time delay to a second component of the electromagnetic wave. The time-dependent module is configured to respond to a control signal to apply a first transformation to the first component at a first time and to apply a second transformation to the second component at a second time that is later than the first time by the difference between the first time delay and the second time delay.

### CROSS-REFERENCE TO RELATED APPLICATIONS

This application claims priority to U.S. Application Ser. No. 60/822,800, filed on Aug. 18, 2006.

### STATEMENT AS TO FEDERALLY SPONSORED RESEARCH

This invention was made with government support under contract no. 60NANB5D1004, O.S.P. project no. 6897722, awarded by US Dept. of Commerce, NIST. The government has certain rights in the invention.

### BACKGROUND

The invention relates to converting optical information encoding.

Optical communication systems encode information on electromagnetic waves using any of a variety of techniques. The electromagnetic waves are typically “light waves” or “optical waves” whose spectral content is in the optical portion of the electromagnetic spectrum, which includes, for example, the visible spectrum, the infrared (IR) spectrum, and the ultraviolet (UV) spectrum. Some systems encode information based on the presence or absence of a pulse of light in a given time slot to represent a logical zero “0” or one “1” (a bit of information). In some cases, multiple characteristics of an optical wave are used to represent one or more bits of information, such as amplitude, phase, and/or polarization. Some systems also use multiple wavelengths of light to encode multiple channels of information.

Some optical communication systems encode information using quantum states of light. Weak coherent light sources, including nonlinear sources, can generate light that includes single photons having a well-defined state (e.g., a given spatial mode and a given polarization state). The quantum state of a photon can include a superposition of multiple basis states. The superposition state can be used to encode a quantum bit (or “qubit”). The state of a qubit can be represented by a two-dimensional complex vector α|0 [symbol] +β|1 [symbol] , where α and β are complex numbers, and |0 [symbol] and |1 [symbol] are orthogonal quantum states. The qubit has a probability |α|² of being measured in the state |0 [symbol] and a probability |β²|=1−|α|² of being measured in the state |1 [symbol] . Not all qubits are in a superposition state (e.g., if either α or β is zero). The states |0 [symbol] and |1 [symbol] can correspond to a predetermined characteristic of a photon that can have multiple possible states, such as polarization (e.g., orthogonal polarization states such as horizontal and vertical), or a spatial mode defining a given position in space and time (e.g., different pulse locations separated by more than the width of the pulse).

A “polarization encoded” optical wave can include, for example, a stream of light pulses that each have first a component in a horizontal polarization state and a second component in a vertical polarization state. Alternatively, the first and second components can correspond to other orthogonal polarization states, such as left and right circularly polarized states. The optical wave can encode a classical signal in which each pulse includes many photons, or a quantum signal in which each pulse corresponds to a single photon (or small number of photons). A polarization encoded optical wave can also include, for example, a stream of photons that are each in a quantum superposition of orthogonal polarization states (e.g., |α|=|β|=1/\sqrt{2}). In any of these cases, information can be encoded in the relative phase between the polarization states.

Communications systems can include devices that convert an encoding of a signal onto an optical wave from polarization encoding to “time-bin encoding” (also called “phase encoding”) in which information is encoded in the relative phase between two time-resolved components of an optical wave. The time-resolved components can correspond, for example, to pulses of an optical wave at different time locations separated by a predetermined time delay. In a quantum communication system, the time-resolved components can correspond to two possible time bins in which a photon in a quantum superposition state can be measured. One example of such a converter delays the input polarization components of a polarization encoded signal relative to one another by propagating the components along different paths, rotates one of the components, and combines the components in a substantially polarization insensitive 50-50 beam splitter so that, at the spatial point where the two paths meet, the polarizations and spatial modes from each path overlap, with the signal along one path temporally delayed relative to the other path.

### SUMMARY

In part, the invention is based on the realization that loss can be reduced when converting between polarization encoding and time-bin encoding by synchronizing a time-dependent module to a time delay associated with the time-bin encoding.

We now summarize various aspects and features of the invention.

In one aspect, in general, an apparatus for converting information encoding on an electromagnetic wave includes a delay module and a time-dependent module. The delay module is configured to apply a first time delay to a first component of an electromagnetic wave and to apply a second time delay different from the first time delay to a second component of the electromagnetic wave. The time-dependent module is configured to respond to a control signal to apply a first transformation to the first component at a first time and to apply a second transformation to the second component at a second time that is later than the first time by the difference between the first time delay and the second time delay. The time-dependent module is configured to apply the first and second transformations, respectively, to the first component and second component received along substantially the same propagation axis.

This and other aspects can include one or more of the following features.

The effect of the second transformation on the second component is different from an effect of the first transformation on the second component.

The apparatus further comprises a control signal source configured to apply the control signal to the time-dependent module such that the first transformation corresponds to a first polarization transformation, and the second transformation corresponds to a second polarization transformation different from the first polarization transformation.

The control signal source is configured to apply a sinusoidal control signal.

The delay module is configured to apply the time delays respectively to first and second polarization components of an input optical wave.

The first and second polarization components are substantially orthogonal.

The first and second polarization components correspond to substantially perpendicular linear polarization states.

The time-dependent module is configured to receive the time-delayed polarization components from the delay module and to apply the transformations to provide an output optical wave having components at different time locations that have substantially the same polarization state.

The polarization state comprises a linear polarization state.

The time-dependent module is configured to apply the transformations respectively to components at first and second time locations of an input optical wave.

The components at the first and second time locations have substantially the same polarization state.

The polarization state comprises a linear polarization state.

The delay module is configured to receive the transformed components from the time-dependent module and to apply the time delays to provide an output optical wave having components at substantially the same time location that have different polarization states.

The delay module comprises: an input port associated with a first polarization state and a second polarization state; an output port associated with a third polarization state and a fourth polarization state; a first path between the input port and output port coupling a polarization component having the first polarization state to a polarization component having the third polarization state; and a second path between the input port and output port coupling a polarization component having the second polarization state to a polarization component having the fourth polarization state.

The input port comprises a first port of a first polarizing beam splitter, the first polarization state is defined by a second port of the first polarizing beam splitter, and the second polarization state is defined by a third port of the first polarizing beam splitter.

The output port comprises a first port of a second polarizing beam splitter, the third polarization state is defined by a second port of the second polarizing beam splitter, and the fourth polarization state is defined by a third port of the second polarizing beam splitter.

The time-dependent module comprises a polarization modulator configured to transform a polarization state of an electromagnetic wave according to the control signal.

The polarization modulator comprises an electro-optic modulator configured to apply a relative phase shift between polarization components of an electromagnetic wave according to a voltage control signal.

The apparatus further comprises a control signal source configured to apply the control signal to the polarization modulator such that the first transformation corresponds to a first relative phase shift between orthogonal polarization components, and the second transformation corresponds to a second relative phase shift between orthogonal polarization components that differs from the first relative phase shift by approximately 180 degrees.

The control signal source is configured to apply a sinusoidal control signal.

The period of the sinusoidal control signal is approximately twice the difference between the first time delay and the second time delay.

The control signal source is configured to apply a periodic control signal having a substantially constant amplitude over a first time duration around the maximum of the control signal, and a substantially constant amplitude over a second time duration around the minimum of the control signal.

The first and second time durations are approximately equal.

The apparatus further comprises a quarter-wave shifter configured to apply a relative phase shift of approximately 90 degrees to a first polarization component relative to a second polarization component.

The quarter-wave shifter comprises a quarter-wave plate.

The delay module is arranged to intercept an electromagnetic wave propagating through the apparatus between the quarter-wave shifter and the time-dependent module.

The apparatus further comprises a polarization controller configured to align a polarization state of an input electromagnetic wave to a predetermined polarization state.

The time-dependent module is arranged to intercept an electromagnetic wave propagating through the apparatus between the polarization controller and the delay module.

In another aspect, in general, a system comprises a source of photons in a superposition of orthogonal polarization states; and the apparatus described herein configured to convert the photons from the source and couple converted photons in a superposition of shifted time bin states into an optical fiber. The system can further comprise the optical fiber. The source can generate pairs of polarization-entangled photons, each of which is in a superposition of orthogonal polarization states.

In another aspect, in general, a system comprises an optical fiber; and the apparatus described herein configured to convert photons received from the optical fiber into photons in a superposition of orthogonal polarization states. The system can further comprise a source configured to couple photons in a superposition of shifted time bin states into the optical fiber.

In another aspect, in general, a system comprises a transmitter comprising a first apparatus as described herein configured to couple converted photons in a superposition of shifted time bin states into an optical fiber; and a receiver comprising a second apparatus as described herein configured to convert photons received from the optical fiber into photons in a superposition of orthogonal polarization states. The system can further comprise an auxiliary laser configured to couple an auxiliary signal into the transmitter. The system can further comprise a calibration module configured to adjust the receiver based on the auxiliary signal.

In another aspect, in general, an apparatus for converting information encoding on an electromagnetic wave includes a delay module and a time-dependent module. The delay module is configured apply a first time delay to a first component of an electromagnetic wave and to apply a second time delay different from the first time delay to a second component of the electromagnetic wave. The time-dependent module is configured to respond to a control signal to apply a first transformation to the first component at a maximum of the control signal and to apply a second transformation to the second component at a minimum of the control signal that occurs at a time shift relative to the maximum that is approximately equal to the difference between the first time delay and the second time delay. The control signal comprises a waveform that has a second derivative at the maximum and minimum of approximately zero and a slope between the maximum and minimum no larger than about ten.

This and other aspects can include one or more of the following features.

The waveform has a slope no larger than about two.

The waveform is approximately sinusoidal.

The effect of the second transformation on the second component is different from an effect of the first transformation on the second component.

The apparatus further comprises a control signal source configured to apply the control signal to the time-dependent module such that the first transformation corresponds to a first polarization transformation, and the second transformation corresponds to a second polarization transformation different from the first polarization transformation.

The delay module is configured to apply the time delays respectively to first and second polarization components of an input optical wave.

The first and second polarization components are substantially orthogonal.

The first and second polarization components correspond to substantially perpendicular linear polarization states.

The time-dependent module is configured to receive the time-delayed polarization components from the delay module and to apply the transformations to provide an output optical wave having components at different time locations that have substantially the same polarization state.

The polarization state comprises a linear polarization state.

The time-dependent module is configured to apply the transformations respectively to components at first and second time locations of an input optical wave.

The components at the first and second time locations have substantially the same polarization state.

The polarization state comprises a linear polarization state.

The delay module is configured to receive the transformed components from the time-dependent module and to apply the time delays to provide an output optical wave having components at substantially the same time location that have different polarization states.

The delay module comprises:

an input port associated with a first polarization state and a second polarization state;

an output port associated with a third polarization state and a fourth polarization state;

a first path between the input port and output port coupling a polarization component having the first polarization state to a polarization component having the third polarization state; and

a second path between the input port and output port coupling a polarization component having the second polarization state to a polarization component having the fourth polarization state.

The input port comprises a first port of a first polarizing beam splitter, the first polarization state is defined by a second port of the first polarizing beam splitter, and the second polarization state is defined by a third port of the first polarizing beam splitter.

The output port comprises a first port of a second polarizing beam splitter, the third polarization state is defined by a second port of the second polarizing beam splitter, and the fourth polarization state is defined by a third port of the second polarizing beam splitter.

The time-dependent module comprises a polarization modulator configured to transform a polarization state of an electromagnetic wave according to the control signal.

The polarization modulator comprises an electro-optic modulator configured to apply a relative phase shift between polarization components of an electromagnetic wave according to a voltage control signal.

The apparatus further comprises a control signal source configured to apply the control signal to the polarization modulator such that the first transformation corresponds to a first relative phase shift between orthogonal polarization components, and the second transformation corresponds to a second relative phase shift between orthogonal polarization components that differs from the first relative phase shift by approximately 180 degrees.

The apparatus further comprises a quarter-wave shifter configured to apply a relative phase shift of approximately 90 degrees to a first polarization component relative to a second polarization component.

The quarter-wave shifter comprises a quarter-wave plate.

The delay module is arranged to intercept an electromagnetic wave propagating through the apparatus between the quarter-wave shifter and the time-dependent module.

The apparatus further comprises a polarization controller configured to align a polarization state of an input electromagnetic wave to a predetermined polarization state.

The time-dependent module is arranged to intercept an electromagnetic wave propagating through the apparatus between the polarization controller and the delay module.

In another aspect, in general, an apparatus for converting information encoding on an electromagnetic wave includes a delay module and a time-dependent module. The delay module configured to apply a first time delay to a first component of an electromagnetic wave and to apply a second time delay different from the first time delay to a second component of the electromagnetic wave. The time-dependent module configured to respond to a control signal to apply a first polarization transformation to the first component at a first time and to apply a second polarization transformation to the second component at a second time that is later than the first time by the difference between the first time delay and the second time delay.

This and other aspects can include one or more of the following features.

The effect of the second polarization transformation on the second component is different from an effect of the first polarization transformation on the second component.

The apparatus further comprises a control signal source configured to apply the control signal to the time-dependent module.

The control signal source is configured to apply a sinusoidal control signal.

The delay module is configured to apply the time delays respectively to first and second polarization components of an input optical wave.

The first and second polarization components are substantially orthogonal.

The first and second polarization components correspond to substantially perpendicular linear polarization states.

The time-dependent module is configured to receive the time-delayed polarization components from the delay module and to apply the polarization transformations to provide an output optical wave having components at different time locations that have substantially the same polarization state.

The polarization state comprises a linear polarization state.

The time-dependent module is configured to apply the polarization transformations respectively to components at first and second time locations of an input optical wave.

The components at the first and second time locations have substantially the same polarization state.

The polarization state comprises a linear polarization state.

The delay module is configured to receive the transformed components from the time-dependent module and to apply the time delays to provide an output optical wave having components at substantially the same time location that have different polarization states.

The delay module comprises: an input port associated with a first polarization state and a second polarization state; an output port associated with a third polarization state and a fourth polarization state; a first path between the input port and output port coupling a polarization component having the first polarization state to a polarization component having the third polarization state; and a second path between the input port and output port coupling a polarization component having the second polarization state to a polarization component having the fourth polarization state.

The input port comprises a first port of a first polarizing beam splitter, the first polarization state is defined by a second port of the first polarizing beam splitter, and the second polarization state is defined by a third port of the first polarizing beam splitter.

The output port comprises a first port of a second polarizing beam splitter, the third polarization state is defined by a second port of the second polarizing beam splitter, and the fourth polarization state is defined by a third port of the second polarizing beam splitter.

The time-dependent module comprises an electro-optic modulator configured to apply a relative phase shift between polarization components of an electromagnetic wave according to a voltage control signal.

The apparatus further comprises a control signal source configured to apply the control signal to the electro-optic modulator such that the first polarization transformation corresponds to a first relative phase shift between orthogonal polarization components, and the second polarization transformation corresponds to a second relative phase shift between orthogonal polarization components that differs from the first relative phase shift by approximately 180 degrees.

The control signal source is configured to apply a sinusoidal control signal.

The period of the sinusoidal control signal is approximately twice the difference between the first time delay and the second time delay.

The control signal source is configured to apply a periodic control signal having a substantially constant amplitude over a first time duration around the maximum of the control signal, and a substantially constant amplitude over a second time duration around the minimum of the control signal.

The first and second time durations are approximately equal.

The apparatus further comprises a quarter-wave shifter configured to apply a relative phase shift of approximately 90 degrees to a first polarization component relative to a second polarization component.

The quarter-wave shifter comprises a quarter-wave plate.

The delay module is arranged to intercept an electromagnetic wave propagating through the apparatus between the quarter-wave shifter and the time-dependent module.

The apparatus further comprises a polarization controller configured to align a polarization state of an input electromagnetic wave to a predetermined polarization state.

The time-dependent module is arranged to intercept an electromagnetic wave propagating through the apparatus between the polarization controller and the delay module.

In another aspect, in general, a method for converting information encoding on an electromagnetic wave comprises applying a first time delay to a first polarization component of an electromagnetic wave and applying a second time delay different from the first time delay to a second polarization component of the electromagnetic wave; and applying a first polarization transformation to the first polarization component at a first location and applying a second polarization transformation different from the first polarization transformation to the second polarization component at the first location.

This and other aspects can include one or more of the following features.

The electromagnetic wave comprises a single photon.

The photon corresponds to a superposition of multiple quantum states.

The first polarization component comprises a first quantum state in the superposition, and the second polarization component comprises a second quantum state in the superposition.

The quantum states correspond to polarization states.

The photon corresponds to one of multiple polarization states in a set of polarization states used for communicating information.

The first polarization component corresponds to a first polarization state in the set, and the second polarization component corresponds to a second polarization state in the set.

The first polarization component is orthogonal to the second polarization component before the first and second polarization transformations are applied.

In another aspect, in general, a method for converting information encoding on an electromagnetic wave comprises applying a first polarization transformation to a first component of an electromagnetic wave at a first time and applying a second polarization transformation different from the first polarization transformation to a second component of the electromagnetic wave at a second time; and applying a first time delay to the first electromagnetic wave component and applying a second time delay to the second electromagnetic wave component. The first time delay is longer than the second time delay by the difference between the first time and the second time.

This and other aspects can include one or more of the following features.

The electromagnetic wave comprises a single photon.

The photon corresponds to a superposition of multiple quantum states.

The first electromagnetic wave component comprises a first quantum state in the superposition, and the second electromagnetic wave component comprises a second quantum state in the superposition.

The quantum states correspond to time bins.

The photon corresponds to one of multiple time bins in a set of time bins used for communicating information.

The first electromagnetic wave component corresponds to a first time bin in the set, and the second electromagnetic wave component corresponds to a second time bin in the set.

The first electromagnetic wave component has substantially the same polarization state as the second electromagnetic wave component before the first and second polarization transformations are applied.

Aspects can have one or more of the following advantages.

The optical encoding converter provides low loss conversion between polarization encoded and time-bin encoded optical signals. The converter can be configured to convert from polarization encoding to time-bin encoding or from time-bin encoding to polarization encoding. The converters are useful for interconnecting free-space based quantum key distribution (QKD) systems (often using polarization encoded qubits) and fiber-optic based QKD systems (often using time-bin encoded qubits since standard telecom fiber does not preserve polarization), and as basic building blocks for various quantum communication networks involving multiple qubit encoding modalities. The converter enables time-bin encoded qubits to be transmitted over optical fibers, and enables polarization encoded qubits to be detected, eliminating a 3-dB-per-node detection penalty associated with standard time-bin encoded qubit measurement approaches. The lower loss penalty yields a potentially higher key generation rate. Furthermore, the smaller required spacing between successive pulses for polarization encoded qubit measurements enables a higher repetition rate and correspondingly higher key generation rate.

Unless otherwise defined, all technical and scientific terms used herein have the same meaning as commonly understood by one of ordinary skill in the art to which the invention belongs. In case of conflict with publications, patent applications, patents, and other references mentioned incorporated herein by reference, the present specification, including definitions, will control.

Other features and advantages will become apparent from the following description, and from the claims.

### DESCRIPTION OF DRAWINGS

FIGS. 1A and 1B are block diagrams of optical encoding converters.

FIGS. 2A and 2B are block diagrams of converters controlled by a driver.

FIGS. 3A, 3B, and 3C are plots of exemplary control signal waveforms.

FIGS. 4A and 4B are block diagrams of converters in different modes of operation.

FIGS. 5A and 5B are block diagrams of transmitter and receiver portions of an optical communication system.

FIGS. 5C and 5D are block diagrams of transmitter and receiver portions of an optical communication system.

### DESCRIPTION

Various quantum communication systems use photons to encode and transmit quantum information (e.g., qubits) used for various applications such as quantum cryptography or quantum computing. Encoding the quantum information onto photons enables propagation of quantum states between entities, in some cases over long distances. Various communication protocols use quantum states of light to provide desired characteristics. For example, Quantum Key Distribution (QKD) uses quantum states of light to distribute a secret key securely. Different QKD protocols use different types of quantum states, including randomized states, superposition states, or entangled states, for example. A quantum communication system can map these states onto the states of photons. Many quantum protocols rely on single-photon states, however, some protocols can include states having multiple photons and retain security benefits, for example, using techniques such as error correction and privacy amplification.

A randomized state can be represented by a photon in a random (e.g., pseudorandomly selected) but well-defined polarization state. For example, a QKD protocol by Charles H. Bennett and Gilles Brassard (“BB84”) uses photons in one of four possible states corresponding to one of two randomly selected sets of orthogonal basis states. One set of basis states (H/V) can be horizontal (0 degrees) and vertical (90 degrees). The other set of basis states (D/A) can be diagonal (45 degrees) and anti-diagonal (135 degrees), or alternatively, left-hand circular and right-hand circular. For each bit, the sender (Alice) encodes a “0” onto either 0 degrees or 45 degrees, or encodes a “1” onto either 90 degrees or 135 degrees, depending on whether a “0” or “1” is to be sent and which set of basis states is randomly selected. The receiver (Bob) randomly selects one of the sets of basis states in which to measure the received photon. Bob then communicates to Alice which set of basis states was used to measure each photon. Alice communicates to Bob which of those sets were “correct” (i.e., the same as the set of states used to encode the photon). The correct measurements are used and the incorrect measurements are discarded.

An entangled state can be represented by a photon in an entangled state. In quantum systems that use entangled states, multiple photons (and the respective qubits that they represent) are “entangled” such that the outcome of a measurement of one of the photons affects, or depends on, the outcome of a measurement of another of the photons. Each of an entangled pair of photons may be in a superposition state with a predetermined probability of being measured in one of two different states; however, once a first photon of the pair is measured, the state of the second photon can be deduced from the measurement. For example, a QKD protocol by Artur Ekert (“Ekert91”) uses pairs of entangled photons to distribute a secret key securely. Other types of quantum communication protocols, such as quantum teleportation, also use pairs of entangled qubits shared between Alice and Bob as a communication resource. The qubits can be generated as a pair of entangled photons, and one or both of the photons can be transmitted to Alice and Bob. If one member of a pair is generated locally to Alice (Bob), then the other member of the pair is transmitted to Bob (Alice). The pair may also be generated at a third entity with one member transmitted to Alice and the other member transmitted to Bob. In some cases, the qubit can be stored by transferring the quantum state of the photon to trapped particle, for example.

A photon that encodes a qubit (e.g., a member of a pair of entangled qubits) can be transmitted over long distances in an optical fiber. If the photon is polarization encoded, techniques can be used to ensure the polarization state is recovered at the receiving end of the optical fiber; however, some polarization effects due to propagation in the optical fiber, such as polarization mode dispersion (PMD), can be difficult to compensate for. A converter can be used to convert a polarization encoded optical wave into a time-bin encoded optical wave so that the two states of the qubit (e.g., pulse modes separated by a few nanoseconds or less) undergo substantially the same polarization effects due to propagation in the optical fiber. The converter enables sources of polarization-entangled photons (spontaneous parametric downconverters) to be used, while allowing one (or both) of the photons to be converted for easy transmission over long distances in optical fibers.

At the receiving end of the fiber, a time-bin encoded qubit can be measured using an appropriate time-bin measurement apparatus. However, in some cases, the time-bin measurement incurs a penalty (e.g., a 3 dB penalty) due to increased loss that results from the time-bin measurement as compared to a polarization measurement. In some QKD protocols, each 3 dB loss penalty at a receiver reduces the potential key generation rate by 3 dB. In addition to the increased loss, time-bin measurements also incur a rate penalty due to the need to space photons further apart so that the time bins used for measurement don't overlap. Measurement of polarization encoded qubits can avoid these penalties. Thus, a converter can be used at the end of an optical fiber to convert a time-bin encoded optical wave into a polarization encoded optical wave for measurement by a polarization measurement apparatus.

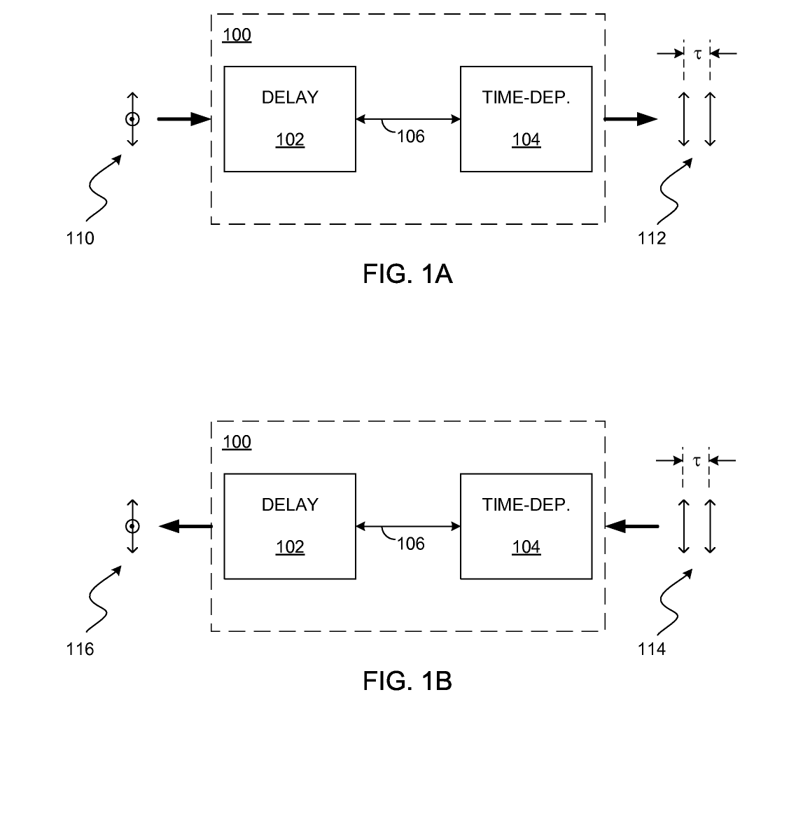

Referring to FIG. 1A, a converter 100 is able to convert from a polarization encoded optical wave 110 to a time-bin encoded optical wave 112. The converter 100 includes a delay module 102 that is configured to apply a first time delay to a first component (e.g., a vertically (V) polarized component) of the polarization encoded optical wave 110 and to apply a second time delay different from the first time delay to a second component (e.g., a horizontally (H) polarized component) of the optical wave 110. The time difference between the first and second time delays is τ. The converter 100 also includes a time-dependent module 104 configured to respond to a control signal to apply a first transformation to the first component at a first time t₁ and to apply a second transformation to the second component at a second time t₂=t₁+τ. For example, the time-dependent module 104 can be a polarization modulator configured to transform a polarization state of an optical wave according to the control signal. The combination of the time delays and the transformations yield the time-bin encoded optical wave 112 that includes the first and second components that have substantially the same polarization and are separated by the time difference τ.

In some approaches to converting from polarization encoding to time-bin encoding that do not use a time-dependent module, loss is associated with the conversion. For example, in one approach, different delays are applied to horizontal and vertical polarization components of a polarization encoded optical wave, one of the components is rotated, and the components are combined in a substantially polarization insensitive 50-50 beam splitter. The polarization of one of the components is rotated so that when the beam splitter reflects one component and transmits the other component to exit the same port of the beam splitter, the resulting spatially overlapped components form a time-bin encoded optical wave whose components have substantially the same polarizations and are temporally delayed relative to one another.

In this approach, since the polarizations and spatial modes (and wavelengths) of the components are the same when each component hits the 50-50 beam splitter, half of the power in that component is lost. This amounts to a 3 dB loss due to the beam splitter since half of each component is lost through the other port of the beam splitter. Similarly, in schemes that use polarization encoded qubits, the qubit exits the “correct” port only half of the time, also resulting in a 3 dB loss due to the beam splitter.

The converter 100 is able to avoid this loss associated with the 50-50 beam splitter. For example, in some implementations, time-dependent module 104 is configured to apply the first and second transformations, respectively, to the first component and second component received along substantially the same propagation axis 106. The converter 100 can combine the two time-delayed polarization components into substantially the same spatial mode (including substantially the same propagation axis), and subsequently transform the polarizations of the two components differently at different times to yield a time-bin encoded optical wave whose components have substantially the same polarizations.

The time-dependence of the time-dependent module 104, as determined by an appropriate control signal, enables the module 104 to apply a first transformation (e.g., a polarization rotation by θ) to the earlier component, and to apply a second transformation (e.g., a polarization rotation by θ+π/2) to the later component such that the effect of the second transformation on the later component is different from an effect on the second component that would result from the first transformation. By performing the polarization transformations after the combining (in the polarization to time-bin conversion mode of operation), the converter 100 can use polarization to combine the components without substantial loss (e.g. using a polarizing beam splitter (PBS) as a combiner).

In other implementations of the converter 100, the time-dependent module 104 does not necessarily apply transformations to components received along substantially the same propagation axis. For example, the time-dependent module 104 may apply the polarization transformations before outputting the components along the same propagation axis. In some implementations, time-dependent module 104 may transform characteristics of an optical wave other than polarization. The time-dependence of the transformations can still be used to perform conversion that avoids the loss associated with a 50-50 beam splitter.

Referring to FIG. 1B, the converter 100 is also able to convert from a time-bin encoded optical wave 114 to a polarization encoded optical wave 116. In this mode of operation, the time-dependent module 104 applies, in response to a control signal, a first transformation to a first (earlier) component of the optical wave 114 at a first time t₁ and applies a second transformation to a second (later) component of the optical wave 114 at a second time t₂=t₁+τ. The time-dependent module 104 transforms the polarizations of the two components from the same polarization state (e.g., a linear (H) polarization state) to orthogonal polarization states (e.g., perpendicular (H and V) polarization states). The delay module 102 applies a first time delay to the earlier component (e.g., V polarized component) and applies a second time delay smaller than the first time delay to the later component (e.g., H polarized component). The time difference τ between the first and second time delays is matched to the time delay between the first and second components to yield the polarization encoded optical wave 116 that includes the first and second components that have substantially orthogonal polarizations and are located at substantially the same location in time and space.

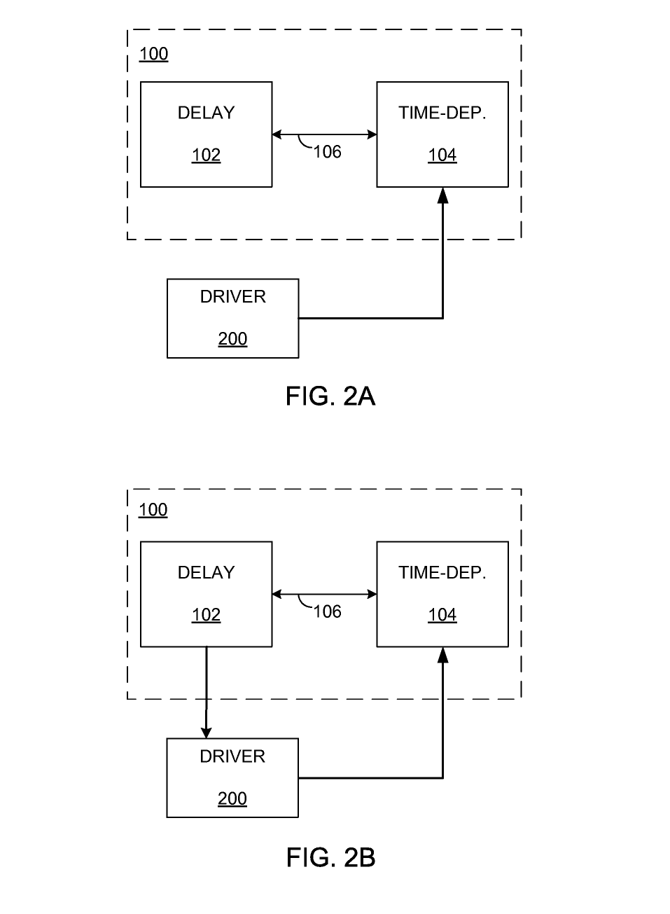

Referring to FIG. 2A, a driver 200 is configured to apply a control signal to the time-dependent module 104 such that the time-dependent module 104 applies different transformations at times t₁ and t₂=t₁+τ. In an example in which the time-dependent module 104 is a polarization modulator, the module 104 defines orthogonal axes (a “fast axis” and a “slow axis”) along which the module 104 applies different phase shifts to fast and slow polarization components of an optical wave propagating through the module 104. The control signal applied by the driver 200 determines the difference between these phase shifts, or the “relative phase shift” between the fast and slow components. In some implementations, as shown in FIG. 2B, the driver 200 receives feedback from the delay module 102 providing an indication of the time difference τ to tune the timing of the control signal. For example an auxiliary optical wave having a different wavelength from an operative wavelength of the converter 100 can be used to determine the effect of the delay module 102 on different components and the resulting value of τ.

As an example of a polarization modulator, an electro-optic modulator can be configured to apply a relative phase shift between fast and slow polarization components according to a voltage control signal. The voltage is applied across an electro-optic medium of the modulator. During operation, the fast and slow axes of the modulator are aligned at 45 degrees relative to the H and V polarization components of the optical wave. The driver 200 is configured to apply a control signal to the modulator such that the first transformation corresponds to a first relative phase shift at t₁, and the second transformation corresponds to a second relative phase shift at t₂. When the relative phase shift is approximately 0 degrees then the component that is within the medium of the modulator at that time (e.g., either H or V) does not undergo a polarization rotation. When the relative phase shift is approximately 180 degrees (a half-wave shifter) then the component that is within the medium of the modulator at that time (e.g., either H or V) undergoes a polarization rotation of 90 degrees (e.g., from H to V, or from V to H). Thus, the first relative phase shift at t₁ and the second relative phase shift at t₂ can be 180 and 0 respectively, or 0 and 180 respectively, for example, depending on whether the earlier or later polarization component is to be rotated. Relative phase shifts of 180 and 0 produce polarization rotations of 90 and 0, and relative phase shifts of 0 and 180 produce rotations of 0 and 90. In the polarization encoding to time-bin encoding conversion mode (FIG. 1A), one or both components are rotated to place the components into the same polarization state. In the time-bin encoding to polarization encoding conversion mode (FIG. 1B), one or both components are rotated to place the first component into the polarization state that undergoes the longer delay in the delay module 102 and the second component into the polarization state that undergoes the shorter delay in the delay module 102.

The modulator can apply other polarization transformations depending on which input polarization states the converter 100 is configured to use. In some implementations, both linearly polarized components can be rotated such that the amount of rotation differs by 90 degrees. In some implementations, instead of rotation between H and V linearly polarized components, the modulator transforms between left and right circularly polarized components.

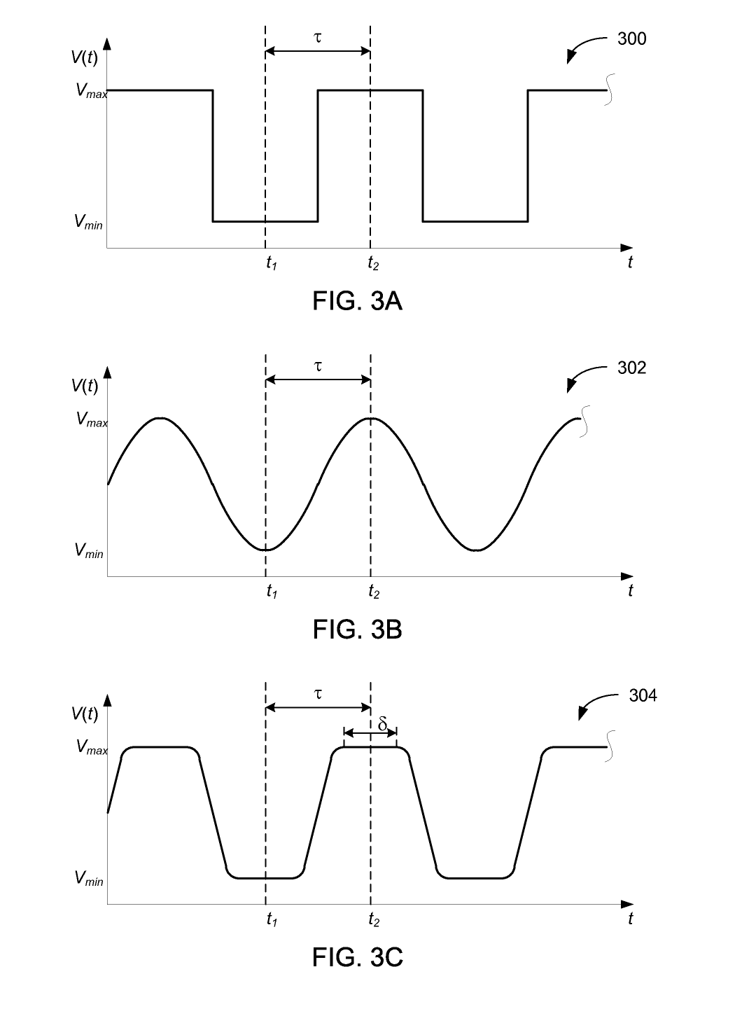

Referring to FIG. 3A, the control signal that the driver 200 applies to the time-dependent module 104 can correspond to a rectangular waveform 300. At time t₁ the driver 200 applies a voltage Vₘᵢₙ corresponding to the first relative phase shift, and at time t₂ the driver 200 applies a voltage Vₘₐₓ corresponding to the second relative phase shift. For example, the peak-to-peak voltage Vₘₐₓ−Vₘᵢₙ corresponds to a change in the relative phase shift by 180 degrees. The frequency of the waveform 300 is

$$\frac{1}{2 τ} .$$

(Alternatively, the frequency of the waveform 300 could be a multiple of

$$\frac{1}{2 τ} .$$

The arrival of the polarization or time-bin components of a signal encoded on the input optical wave can be synchronized to the waveform 300 so that t₁ and t₂ occur near the middle of the voltage steps to allow a large tolerance for timing errors (e.g., in the expected arrival times of the pulses).

Alternatively, as shown in FIG. 3B, the control signal can correspond to a sinusoidal waveform 302. In this case, the driver 200 also applies the voltage Vₘᵢₙ at time t₁ and the voltage Vₘₐₓ at time t₂. However, in this case, the driver 200 does not need to have as large a bandwidth since the sinusoidal waveform 302 at the same frequency as the rectangular waveform 300 does not contain the higher frequency components associated with the steep slope of the rectangular waveform 300. While sinusoidal waveform 302 does not have as great a tolerance to timing errors as does the rectangular waveform 300, the fact that the sinusoid has a second derivative at the maximum and minimum of zero does provide some tolerance to timing errors.

FIG. 3C shows a control signal waveform 304 that represents a compromise between low bandwidth requirements and tolerance to timing errors. The waveform 304 has a substantially constant amplitude over a time duration δ around each of the maximum and minimum of the control signal, and a slope between the maximum and minimum that is not as steep as the slope of the rectangular waveform 300 (e.g., no larger than about ten, or no larger than about two).

In each of these cases, the arrival of the polarization or time-bin components of the signal encoded on the input optical wave are synchronized to the control signal waveform so that the appropriate transformations are applied when the respective components arrive at the time-dependent module 104. If the spacing between successive polarization or time-bin encoded signals is not a multiple of τ, then the phase of the control signal can be adjusted between signals to achieve synchronization.

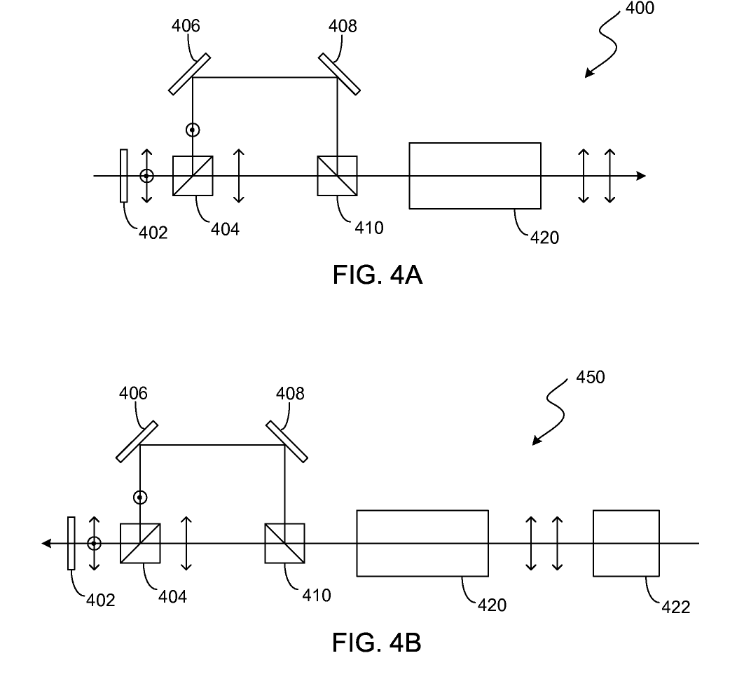

FIG. 4A shows an exemplary implementation of a converter 400 configured in a polarization encoding to time-bin encoding (PT) conversion mode. For protocols, such as BB84, that encode a signal onto an optical wave using the polarization bases H/V and D/A, the converter 400 includes an input quarter-wave shifter 402 (e.g., a quarter-wave plate) configured to apply a relative phase shift of 90 degrees to a polarization component along a fast axis relative to a polarization component along a slow axis. The fast and slow axes can be aligned along D and A so that D and A polarization states are maintained (with an added relative phase shift of 90 degrees between D and A), but H and V polarization states are transformed into left and right circularly polarized states, respectively. This selective transformation maintains approximately equal amplitudes for the resulting time-bin components regardless of whether the input polarization encoding basis is H/V or D/A. For protocols that use a single polarization encoding basis, the quarter-wave shifter 402 can be eliminated.

The delay module of the converter 400 includes a first polarizing beam splitter (PBS) 404 that separates an optical wave received at an input port into vertically and horizontally polarized components V and H propagating out of different output ports. The H component travels over a short path through the PBS 404 to an input port of a second PBS 410. The V component travels over a long path (longer by cτ, where c is the speed of light) reflecting from mirrors 406 and 408 to another input port of the second PBS 410. The second PBS 410 combines the time delayed (by τ) H and V components to propagate from an output port along the same propagation axis to a time-dependent module 420. Alternatively, other components can be used to form the short and long polarization-sensitive paths. For example, the first PBS 404 and second PBS 410 can be polarizing components that are fiber coupled and connected by short and long sections of optical fiber to form the short and long paths.

FIG. 4B shows an exemplary implementation of a converter 450 configured in a time-bin encoding to polarization encoding (TP) conversion mode. In the TP mode of operation, the converter 450 can include a polarization controller 422 to ensure that the polarization state of the components of the received time-bin encoded optical wave are properly aligned with respect to the fast and slow axes of the time-dependent module 420. If the input polarization state of both components is aligned to H, the time dependent module 420 rotates the polarization of the earlier component to V and maintains the polarization of the later component at H, according to the control signal. The orthogonally-polarized and time-delayed components then pass through the PBS 410 to separate the earlier V component to propagate along the long path, and the later H component to propagate along the short path. The orthogonally-polarized and temporally-coincident components are then combined in the PBS 404 to propagate out of the same output port as a polarization encoded optical wave. If the TP mode converter 450 is being used to re-convert an optical wave that was previously converted by a PT mode converter 400, the converter 450 can include the quarter-wave shifter 402 at the output to undo the 90 degree phase shift imposed by the quarter-wave shifter 402 in the PT mode converter 400.

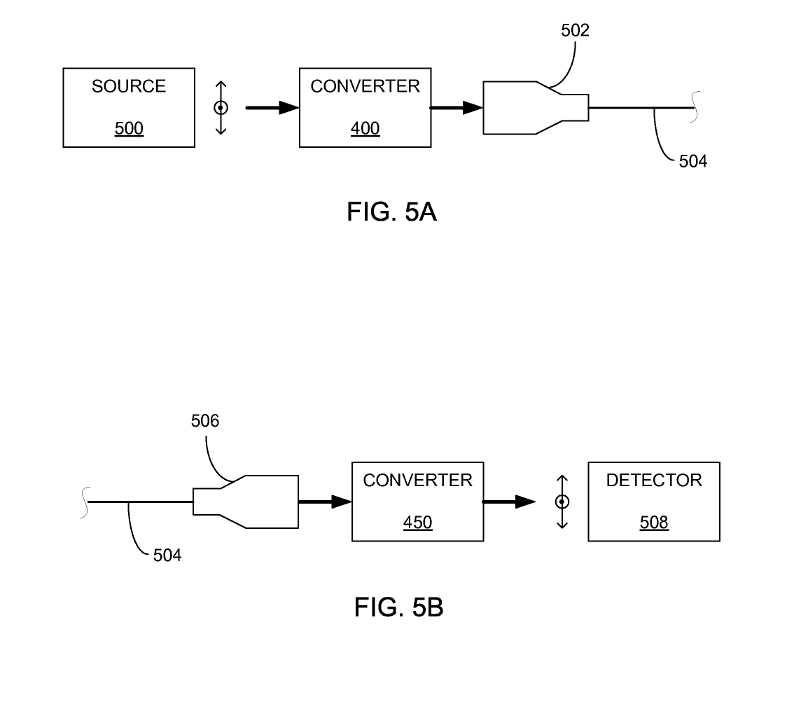

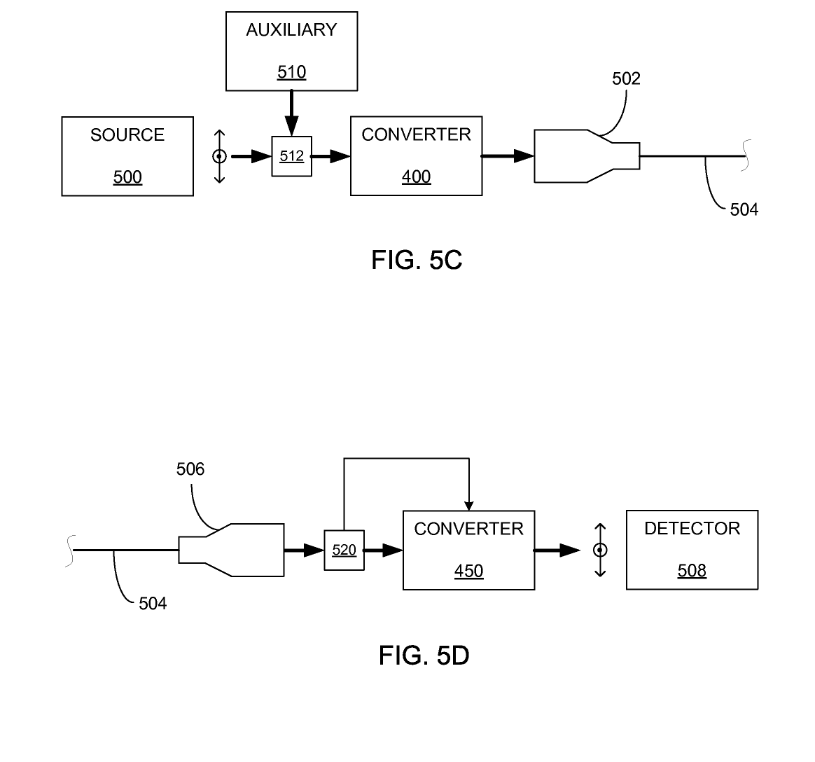

For example, FIGS. 5A and 5B show transmitter and receiver portions of an optical communication system. At the transmitter, a source 500 (e.g., a source of photons in a quantum superposition of orthogonal polarization states) provides a polarization encoded optical wave to a PT mode converter 400. The resulting time-bin encoded optical wave (e.g., photons in a quantum superposition of shifted time bin states) is coupled by a fiber coupler 502 into an optical fiber 504 for transport to a detector 508 at the receiver. At the receiving end of the optical fiber 504, a fiber coupler 506 couples the optical wave into a TP mode converter 450 to provide a polarization encoded optical wave to the detector 508 (e.g., photons converted back into a quantum superposition of orthogonal polarization states).

In some implementations, an optical communication system is configured to calibrate characteristics of the converters, such as the differential delay τ imposed by the delay module 102. The delay imposed by the delay module in the PT mode converter 400 should be substantially the same as the delay removed by the delay module in the TP mode converter 450. Referring to FIG. 5C, the encoded optical wave from the source 500 can be combined in a wavelength division multiplexer 512 with an auxiliary optical wave that is shifted in wavelength from the operative wavelength of the source 500 to transmit an auxiliary signal through the optical fiber 504 that indicates the differential time delay τ imposed by the delay module 102 in the PT mode converter 400. For example, an auxiliary signal has a wavelength that can be separated from the operative wavelength by an optical filter, but is close enough in wavelength to provide pulses separated by substantially the same time delay that is imposed at the operative wavelength. At the receiving end, referring to FIG. 5D, a calibration module 520 can detect the auxiliary optical wave and measure the time delay τ to provide a calibration signal for adjusting the differential delay imposed by the delay module 102 in the TP mode converter 450. The delay of the TP mode converter 450 can be phase-locked to the delay of the PT mode converter 400 to compensate for thermal and/or mechanical vibrations, for example. In some systems, the auxiliary source 510 is not needed, and the calibration module 520 can calibrate the TP mode converter 450 based on the encoded optical wave itself.

The calibration module 520 can also calibrate other characteristics of the TP mode converter 450. For example, the calibration module 520 can track the polarization of the optical wave (e.g., using the single-photon counting measurements in the case of photon qubits) to provide a signal for adjusting the polarization controller 422. The polarization state (of both time separated components) can also be transformed, if necessary, from an elliptical state to a linear state.

Other embodiments are within the scope of the following claims.

What is claimed is:

1. An apparatus for converting information encoding on an electromagnetic wave, the apparatus comprising:
a delay module configured to apply a first time delay to a first component of an electromagnetic wave and to apply a second time delay different from the first time delay to a second component of the electromagnetic wave; and
a time-dependent module configured to respond to a control signal to apply a first transformation to the first component at a first time and to apply a second transformation to the second component at a second time that is later than the first time by the difference between the first time delay and the second time delay, and wherein the time-dependent module is configured to apply the first and second transformations, respectively, to the first component and second component received along substantially the same propagation axis.

2. The apparatus of claim 1, wherein the effect of the second transformation on the second component is different from an effect of the first transformation on the second component.

3. The apparatus of claim 1, further comprising a control signal source configured to apply the control signal to the time-dependent module such that the first transformation corresponds to a first polarization transformation, and the second transformation corresponds to a second polarization transformation different from the first polarization transformation.

4. The apparatus of claim 3, wherein the control signal source is configured to apply a sinusoidal control signal.

5. The apparatus of claim 1, wherein the delay module is configured to apply the time delays respectively to first and second polarization components of an input optical wave.

6. The apparatus of claim 5, wherein the first and second polarization components are substantially orthogonal.

7. The apparatus of claim 6, wherein the first and second polarization components correspond to substantially perpendicular linear polarization states.

8. The apparatus of claim 5, wherein the time-dependent module is configured to receive the time-delayed polarization components from the delay module and to apply the transformations to provide an output optical wave having components at different time locations that have substantially the same polarization state.

9. The apparatus of claim 8, wherein the polarization state comprises a linear polarization state.

10. The apparatus of claim 1, wherein the time-dependent module is configured to apply the transformations respectively to components at first and second time locations of an input optical wave.

11. The apparatus of claim 10, wherein the components at the first and second time locations have substantially the same polarization state.

12. The apparatus of claim 11, wherein the polarization state comprises a linear polarization state.

13. The apparatus of claim 10, wherein the delay module is configured to receive the transformed components from the time-dependent module and to apply the time delays to provide an output optical wave having components at substantially the same time location that have different polarization states.

14. The apparatus of claim 1, wherein the delay module comprises:
an input port associated with a first polarization state and a second polarization state;
an output port associated with a third polarization state and a fourth polarization state;
a first path between the input port and output port coupling a polarization component having the first polarization state to a polarization component having the third polarization state; and
a second path between the input port and output port coupling a polarization component having the second polarization state to a polarization component having the fourth polarization state.

15. The apparatus of claim 14, wherein the input port comprises a first port of a first polarizing beam splitter, the first polarization state is defined by a second port of the first polarizing beam splitter, and the second polarization state is defined by a third port of the first polarizing beam splitter.

16. The apparatus of claim 15, wherein the output port comprises a first port of a second polarizing beam splitter, the third polarization state is defined by a second port of the second polarizing beam splitter, and the fourth polarization state is defined by a third port of the second polarizing beam splitter.

17. The apparatus of claim 1, wherein the time-dependent module comprises a polarization modulator configured to transform a polarization state of an electromagnetic wave according to the control signal.

18. The apparatus of claim 17, wherein the polarization modulator comprises an electro-optic modulator configured to apply a relative phase shift between polarization components of an electromagnetic wave according to a voltage control signal.

19. The apparatus of claim 17, further comprising a control signal source configured to apply the control signal to the polarization modulator such that the first transformation corresponds to a first relative phase shift between orthogonal polarization components, and the second transformation corresponds to a second relative phase shift between orthogonal polarization components that differs from the first relative phase shift by approximately 180 degrees.

20. The apparatus of claim 19, wherein the control signal source is configured to apply a sinusoidal control signal.

21. The apparatus of claim 20, wherein the period of the sinusoidal control signal is approximately twice the difference between the first time delay and the second time delay.

22. The apparatus of claim 19, wherein the control signal source is configured to apply a periodic control signal having a substantially constant amplitude over a first time duration around the maximum of the control signal, and a substantially constant amplitude over a second time duration around the minimum of the control signal.

23. The apparatus of claim 22, wherein the first and second time durations are approximately equal.

24. The apparatus of claim 1, further comprising a quarter-wave shifter configured to apply a relative phase shift of approximately 90 degrees to a first polarization component relative to a second polarization component.

25. The apparatus of claim 24, wherein the quarter-wave shifter comprises a quarter-wave plate.

26. The apparatus of claim 24, wherein the delay module is arranged to intercept an electromagnetic wave propagating through the apparatus between the quarter-wave shifter and the time-dependent module.

27. The apparatus of claim 1, further comprising a polarization controller configured to align a polarization state of an input electromagnetic wave to a predetermined polarization state.

28. The apparatus of claim 27, wherein the time-dependent module is arranged to intercept an electromagnetic wave propagating through the apparatus between the polarization controller and the delay module.

29. A system, comprising:
a source of photons in a superposition of orthogonal polarization states; and
the apparatus of claim 1 configured to convert the photons from the source and couple converted photons in a superposition of shifted time bin states into an optical fiber.

30. The system of claim 29, further comprising the optical fiber.

31. The system of claim 29, wherein the source generates pairs of polarization-entangled photons, each of which is in a superposition of orthogonal polarization states.

32. A system, comprising:
an optical fiber; and
the apparatus of claim 1 configured to convert photons received from the optical fiber into photons in a superposition of orthogonal polarization states.

33. The system of claim 32, further comprising a source configured to couple photons in a superposition of shifted time bin states into the optical fiber.

34. A system, comprising:
a transmitter comprising an apparatus of claim 1 configured to couple converted photons in a superposition of shifted time bin states into an optical fiber; and
a receiver comprising an apparatus of claim 1 configured to convert photons received from the optical fiber into photons in a superposition of orthogonal polarization states.

35. The system of claim 34, further comprising an auxiliary laser configured to couple an auxiliary signal into the transmitter.

36. The system of claim 35, further comprising a calibration module configured to adjust the receiver based on the auxiliary signal.

37. An apparatus for converting information encoding on an electromagnetic wave, the apparatus comprising:
a delay module configured apply a first time delay to a first component of an electromagnetic wave and to apply a second time delay different from the first time delay to a second component of the electromagnetic wave; and
a time-dependent module configured to respond to a control signal to apply a first transformation to the first component at a maximum of the control signal and to apply a second transformation to the second component at a minimum of the control signal that occurs at a time shift relative to the maximum that is approximately equal to the difference between the first time delay and the second time delay, and wherein the control signal comprises a waveform that has a second derivative at the maximum and minimum of approximately zero and a slope between the maximum and minimum no larger than about ten.

38. The apparatus of claim 37, wherein the waveform has a slope no larger than about two.

39. The apparatus of claim 38, wherein the waveform is approximately sinusoidal.

40. The apparatus of claim 37, wherein the effect of the second transformation on the second component is different from an effect of the first transformation on the second component.

41. The apparatus of claim 37, further comprising a control signal source configured to apply the control signal to the time-dependent module such that the first transformation corresponds to a first polarization transformation, and the second transformation corresponds to a second polarization transformation different from the first polarization transformation.

42. An apparatus for converting information encoding on an electromagnetic wave, the apparatus comprising:
a delay module configured to apply a first time delay to a first component of an electromagnetic wave and to apply a second time delay different from the first time delay to a second component of the electromagnetic wave; and
a time-dependent module configured to respond to a control signal to apply a first polarization transformation to the first component at a first time and to apply a second polarization transformation to the second component at a second time that is later than the first time by the difference between the first time delay and the second time delay.

43. The apparatus of claim 42, wherein the effect of the second polarization transformation on the second component is different from an effect of the first polarization transformation on the second component.

44. The apparatus of claim 42, further comprising a control signal source configured to apply the control signal to the time-dependent module.

45. The apparatus of claim 44, wherein the control signal source is configured to apply a sinusoidal control signal.

46. A method for converting information encoding on an electromagnetic wave, the method comprising:
applying a first time delay to a first polarization component of an electromagnetic wave and applying a second time delay different from the first time delay to a second polarization component of the electromagnetic wave; and
applying a first polarization transformation to the first polarization component at a first location and applying a second polarization transformation different from the first polarization transformation to the second polarization component at the first location.

47. The method of claim 46, wherein the electromagnetic wave comprises a single photon.

48. The method of claim 47, wherein the photon corresponds to a superposition of multiple quantum states.

49. The method of claim 48, wherein the first polarization component comprises a first quantum state in the superposition, and the second polarization component comprises a second quantum state in the superposition.

50. The method of claim 48, wherein the quantum states correspond to polarization states.

51. The method of claim 47, wherein the photon corresponds to one of multiple polarization states in a set of polarization states used for communicating information.

52. The method of claim 51, wherein the first polarization component corresponds to a first polarization state in the set, and the second polarization component corresponds to a second polarization state in the set.

53. The method of claim 46, wherein the first polarization component is orthogonal to the second polarization component before the first and second polarization transformations are applied.

54. A method for converting information encoding on an electromagnetic wave, the method comprising:
applying a first polarization transformation to a first component of an electromagnetic wave at a first time and applying a second polarization transformation different from the first polarization transformation to a second component of the electromagnetic wave at a second time; and
applying a first time delay to the first electromagnetic wave component and applying a second time delay to the second electromagnetic wave component;
wherein the first time delay is longer than the second time delay by the difference between the first time and the second time.

55. The method of claim 54, wherein the electromagnetic wave comprises a single photon.

56. The method of claim 55, wherein the photon corresponds to a superposition of multiple quantum states.

57. The method of claim 56, wherein the first electromagnetic wave component comprises a first quantum state in the superposition, and the second electromagnetic wave component comprises a second quantum state in the superposition.

58. The method of claim 56, wherein the quantum states correspond to time bins.

59. The method of claim 55, wherein the photon corresponds to one of multiple time bins in a set of time bins used for communicating information.

60. The method of claim 59, wherein the first electromagnetic wave component corresponds to a first time bin in the set, and the second electromagnetic wave component corresponds to a second time bin in the set.

61. The method of claim 54, wherein the first electromagnetic wave component has substantially the same polarization state as the second electromagnetic wave component before the first and second polarization transformations are applied.
